(19) United States
(12) Patent Application Publication
(10) Pub. No.: US 2007/0030120 A1
(43) Pub. Date: Feb. 8, 2007

(54) SECURITY ACCESS CONTROL SYSTEM AND ASSOCIATED METHODS

(75) Inventors: Jesse Gusse, Orlando, FL (US); Jeffrey Schwentner, Orlando, FL (US); James McNeill, Orlando, FL (US); Oscar Fandino, Orlando, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: echoLock, Inc., Orlando, FL (US)

(21) Appl. No.: 11/461,868

(22) Filed: Aug. 2, 2006

Related U.S. Application Data
(60) Provisional application No. 60/704,931, filed on Aug. 2, 2005.

(51) Int. Cl. G05B 19/00

(52) U.S. Cl. 340/5.61; 340/5.64; 340/5.5; 340/825.69

(57) ABSTRACT

A security access control system includes a plurality of security access control devices at respective physical access points for controlling physical access thereat. Each security access control device includes a wireless transnsceiver and a controller cooperating therewith a establish a wireless ad hoc network among the plurality of security access control devices. A host control station includes a wireless transceiver and a host controller cooperating therewith to communicate to at least one of the security access control devices via the wireless ad hoc network.

### RELATED APPLICATION

This application claims the benefit of U.S. Provisional Application Ser. No. 60/704,931 filed Aug. 2, 2005, the entire contents of which are incorporated herein by reference.

### FIELD OF THE INVENTION

The present invention relates to the field of security systems, and more particularly, to a wireless security access control system controlling access to physical access points in response to access media presented by a user.

### BACKGROUND OF THE INVENTION

Most commercial buildings were constructed without the communications infrastructure needed to support modern security access control systems. These systems require the installation of cabling to relay information between physical access points, such as electronic door locks, and a centralized controller where the information can be managed.

The benefit obtained by the flow of real time information often does not outweigh the installation costs of these systems. The most affordable security access control systems typically do not have real time control. With these systems, maintaining a large number of access points, such as a building with several hundred electronic door locks, in a dynamic environment with many users is very labor intensive.

One approach is disclosed in U.S. Pat. No. 6,720,861 to Rodenbeck et al., which is directed to a wireless security access control system. In particular, the wireless security access control system includes a host control station and a plurality of remotely located security access control devices. The host control station uses wireless communication technology to communicate with each security access control device, The host control station is used to program each security access control device so that certain users are granted access through certain doors, and other users are granted access through other doors.

However, a problem in the Rodenbeck et al. patent arises when a remote security access control device is out of range with the host control station, as may typically happen in a large building, To program the remote access control system that is out of range, an individual must walk to and physically connect a programming device to the security access control device. Once the programming device is connected, new user data can be downloaded into the system. This is a tedious and time-consuming approach, particularly if the user data is frequently updated.

### SUMMARY OF THE INVENTION

In view of the foregoing background, it is therefore an object of the present invention to provide a wireless security control system in which a remote security access control device can be wirelessly updated when out of range from a host control station.

This and other objects, features, and advantages in accordance with the present invention are provided by a security access control system comprising a plurality of security access control devices at respective physical access points for controlling physical access thereat. Each security access control device may comprise a wireless transceiver and a controller cooperating therewith to establish a wireless ad hoc network among the plurality of security access control devices.

The security access control system may further comprise at least one additional security access control device that is out of range of the plurality of access control devices, at least one repeater for extending the wireless ad hoc network to the at least one additional security access control device.

The security access control system may further comprise a host control station comprising a wireless transceiver and a host controller cooperating therewith to communicate to at least one of the plurality of security access control devices via the wireless ad hoc network

The wireless ad hoc network advantageously does not require every security access control device to be within range of the host control system Instead, each security access control device needs to be in range with another security access control device or a repeater. The security access control system thus facilitates secure access point communications when using encrypted wireless network technology.

The host control station may transmit control data to at least one of the security access control devices via the wireless ad hoc network The control data may comprise at least one of an unlocked state, a card controlled state, an access disabled state, and a dual mode state for any one of the security access control devices The control data may be used for controlling user access to any one of the physical access points. The control data may also comprise data for tracking, banning, blocking and accepting user access.

At least one of the security access control devices transmits status data to the host control system via the wireless ad hoc network. The status data may comprise at least one of battery status, user status, and security access control device operating status. The status data may be transmitted in real time. The security access control device operating status may comprise at least one of an unlocked state, a card controlled state, an access disabled state, and a dual mode state. In addition, the status data may comprise audit data, wherein the audit data includes system events, access attempts by a user, and a time and access event outcome of the access attempts made by the user.

The controller of the security access control device may comprise a memory, and either a processor or a programmable gate array coupled thereto The memory may store user access control data in a user block list, a user ban list, a user accept list and a user track list.

Each access control device may comprise a lock control driver coupled to the controller Each access control device may comprise at least one of an access media reader, a keypad and a fingerprint sensor for operating the lock control driver. These authentication devices may operate individually or in combination with one another for permitting a user to access a physical access point.

The wireless ad hoc network may operate based upon an ad hoc on demand distance vector (AODV) protocol or a dynamic source routing (DSR) protocol, for example. The physical access points may be fixed physical access points.

Another aspect of the present invention is directed to a security access control method comprising positioning a plurality of security access control devices at respective physical access points, with each security access control device comprising a wireless transceiver and a controller cooperating therewith. The method comprises establishing a wireless ad hoc network among the security access control devices using the wireless transceivers and controllers thereof, and controlling physical access at the physical access points using the security access control devices. The method may further comprise positioning a host control station comprising a wireless transceiver and a host controller cooperating therewith to communicate to at least one of security access control devices via the wireless ad hoc network.

### BRIEF DESCRIPTION OF THE DRAWINGS

FIG. 1 is a block diagram of a wireless security access control system in accordance with the present invention.

FIG. 2 is a more detailed block diagram of one of the security access control devices shown in FIG. 1.

FIG. 3 is a system software 3-tier architecture representation in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

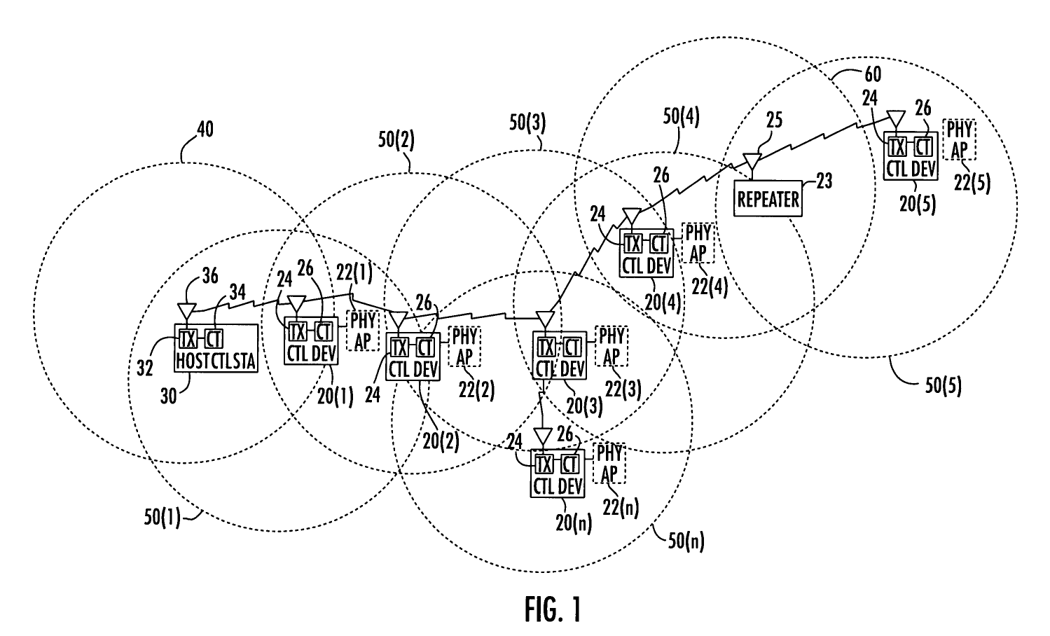

Referring initially to FIG. 1, a security access control system 10 comprises a plurality of security access control devices 20(1)-20(n) at respective physical access points 22(1)-22(n) for controlling physical access thereat. A physical access point 22(1)-22(n) may be any area in which entry by a user needs to be controlled and monitored. For instance, the physical access points 22(1)-22(n) at a university are staff offices, professor offices, lab rooms, supply rooms, etc. These are fixed physical access points.

For discussion purposes, an individual security access control device and an individual physical access point may also be referred to by references 20 and 22, respectively. Each security access control device 20 comprises a wireless transceiver 24 and a controller 26 cooperating therewith to establish a wireless ad hoc network among the security access control devices 20(1)-20(n).

The security access control system 10 may include an additional security access control device 20(5) that is out of range with the other security access control devices 20(1)-20(n). To extend the wireless ad hoc network to the additional security access control device 20(5), at least one repeater 23 is provided. An antenna 25 is coupled to the repeater 23. In the illustrated example, the repeater 23 is operating between security access control devices 20(4) and 20(5).

The security access control system further comprises a host control station 30 comprising a wireless transceiver 32 and a host controller 34 cooperating therewith to communicate to at least one of security access control devices 20(1)-20(n) via the wireless ad hoc network. An antenna 36 is coupled to the transceiver 32. The host control station 30 may be a stand-alone system as shown in FIG. 1, or it may be integrated with one of the security access control devices 20

The wireless ad hoc network advantageously does not require every security access control device 20 to be within range of the host control system 30. Instead, each security access control device 20 needs to be in range with another security access control device or in range of a repeater 23.

As best shown in FIG. 1, the area of coverage by the host control station 30 is represented by zone 40. Similarly, the area of coverage of the security access control devices 20(1)-20(n) is represented by zones 50(1)-50(n), and the area of coverage of the repeater 23 is represented by zone 60. As long as the zones 40, 50(1)-50(n) and 60 overlap, secure access point communications is provided. For example, security access control devices 20(4) and 20(n) are out of range from the host control station 30, and they are out of range from security access control device 20(2). As a result of the wireless ad hoc network, control and status data may be exchanged with security access control devices 20(4) and 20(n) via security access control device 20(3). Similarly, the repeater 23 can relay control and status data to any security access control device 20 that is within range of the repeater but is not within range of another security access control device, as is the case with security access control device 20(5).

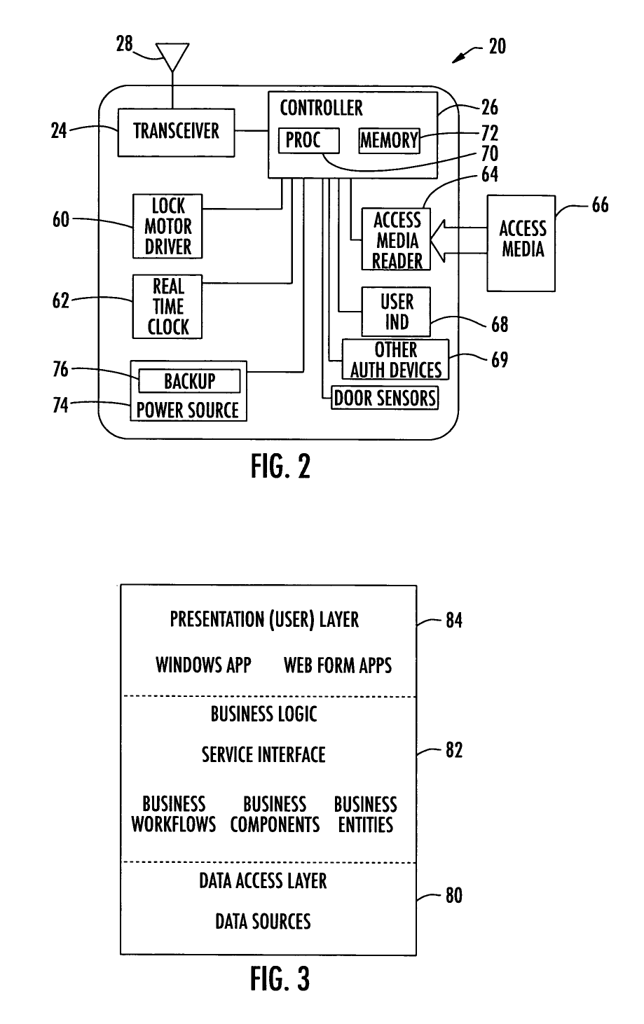

The security access control devices 20(1)-20(n) will now be discussed in greater detail with reference to FIG. 2. Each security access control device 20 is divided into two subsystems, a wireless subsystem and a primary subsystem The wireless subsystem handles all wireless network transactions. It is composed of a radio frequency transceiver 24 and a microcontroller 26. An antenna 28 is coupled to the transceiver 24.

The transceiver 24 is used to transmit and receive radio frequencies and transfer encoded access control data. The microcontroller 26 performs functions required by the wireless protocol, and performs data error checking and forward error correction to minimize communication problems between the security access control devices 20(1)-20(n).

The primary subsystem is composed of a lock control mechanism 60, a real time clock or timer 62, an access media reader 64, the main microcontroller 26 and other authentication devices 69. The other authentication devices 69 include a keypad and a fingerprint sensor, for example.

One or more of the other authentication devices 69 may operate in combination with the access media reader 64 for permitting a user access to a corresponding physical access point 22. Alternatively, the keypad and fingerprint sensor may operate in combination for permitting a user access to a corresponding physical access point 22. Of course, the access media reader 64 and any one of the authentication devices 69 may be used individually for permitting a user access to a corresponding physical access point 22.

The lock motor control or driver 60 uses pulse width modulation to control motor current and speed of rotation. The real time clock 63 is used to keep track of the time of day used during media access validation and for event schedules, which configures the state of the security access control device 20 based on the time (locked, unlocked, card controlled, etc).

The access media reader 64 is used when a user inserts a card 66 to try to gain entry to a door at the physical access point 26. When the card 66 is inserted the card reader 64 initiates communication with the access media (i.e., the card 66) and issues a decryption key. It is then able to check the access media 66 to determine if that user has access to that room. The access attempt is then logged in memory 72. The main microcontroller 26 includes a processor 70 for handling all of the above-mentioned tasks. In lieu of a processor, a programmable gate array may be used, as readily appreciated by those skilled in the art. The main microcontroller 26 also coordinates communication with the transceiver 24 and controls the access media reader 64, event schedules with the real time clock 62, user validation, and motor controls 60.

The access states inherent to each security access control device 20 are an unlocked state, a card controlled state, an access disabled state, and a dual state. The states dictate reaction of a security access control device 20 to a stimulus. The unlocked state relates to a condition in which the physical access point 22 is always in a free entry state. It is always unlocked, regardless of access media 66 insertions.

In the card controlled state, the security access control device 20 is controlled by the actions of an access media 66 stimulus. This allows, for instance, a user presenting a smart card (or other access media) 66 to unlock a door at the physical access point 22. Results of the user presenting the access media 66 are provided via user indicator 68, which includes an LED display, for example.

After entry, the security access control device 20 relocks itself for the next entry attempt. Within this state, users with the proper credentials may enable an office mode. The data used to validate for proper credentials will be discussed in greater detail below

The office mode allows an individual to unlock and lock a physical access point 22 by providing their access media 66 twice in succession. As an example, a professor at a university may unlock their office and leave it unlocked for students to enter. In the access disabled state, the security access control device 20 is in a constant locked state. The security access control device 20 will deny all entry attempts with the access media 66, unless the media is configured as a master key. The dual state is a condition in which the security access control device 20 requires authentication from two access media cards 66 within a short time period for access to be granted. These states may be programmed to occur at certain times, or invoked immediately via the wireless network

Control data from the host control station 30 is used for controlling user access to any one of the physical access points 20(1)-20(n). The control data includes data for tracking, banning, blocking and accepting user access, as discussed in greater detail below.

The security access control system 10 includes the ability to schedule calendar events for all security access control devices 20(1)-20(n). Calendar events are time based actions that will take place at the programmed time. The events were designed to configure the state of any security access control device 20 based on the time of day. They can have a recurrence pattern, and a start and expiration date.

As an example, a system operator may configure a security access control device 20 to enter the card controlled state during business hours, and to enter the access disabled state during non-business hours every weekday and another schedule for weekends. These events can also be used to configure the particular access level a user must meet to gain access, initiate firmware reprogramming, or to configure (or receive) security access control device information at specific times. The various configurations of the security access control devices 20 are set via the ad hoc network from the host control station 30 or from one of the security access control devices 20. In other words, access to the physical access points 22 can be reprogrammed via the wireless ad hoc network

The real time clock 62 of the primary subsystem of each security access control device 20 keeps time so that calendar events are as accurate as possible. All events are configured through the administration software, and sent through the wireless ad hoc network to the appropriate security access control device 20. More particularly, control data from the host control station 30 also includes a table for controlling user access to any one of the physical access points 20(1)-20(n) based certain events occurring at certain times of the day.

All access attempts are stored in the security access control device's 20 internal memory log 72. This log details the date and time along with user and access event outcome of all entry attempts made by a user. In addition, all system events are recorded. These include, but are not limited to, logging of significant battery level changes associated with the power supply 74 (which includes a backup battery source 76), access state changes and other event invocations. At any time this audit (log) information can be down loaded to the host control station 30 via the wireless ad hoc network.

This information can also be provided in real time. In other words, the activities of any particular user is reported as status data to the host control station 30 as soon as the user tries to gain access to any physical access point 22. Similarly, any time access is attempted to any particular physical access point 22, this information is reported as status data to the host control station 30. Other real time events reported back to the host control station 30 include the status of the battery, a door is left open, etc.

Each security access control device 20 contains a region of memory within memory 72 that is allocated for user data. This region is segmented among four distinct user lists: block list, ban list, accept list and track list. Each list contains a configurable set of user IDs. When a user is placed on the block list of a physical access point 22, the security access control device 20 denies all attempts made by the user to gain access. The user will be blocked even if their access media 66 would otherwise allow access.

When placed on the ban list of a physical access point 22, a user is denied entry to the access point, regardless of the user's access media 66. The security access control device 20 also invalidates the access media 66, rendering it useless in the system 10, and then immediately dispatches an event to the controller 26 with a notification of the banned user.

When a user is placed on the accept list of a physical access point 22, the security access control device 20 allows that user access at the time of entry. The user will be accepted even if they do not possess the proper data for that physical access point 22 based on their access media 66. Users placed on the track list of a physical access point 22 are monitored. When a tracked user presents access media to a security access control device 20, that security access control device dispatches an event to the controller 26 containing the user ID, the access event and outcome.

Each security access control device 20 sends information asynchronously to the host control station 30 when a significant event has occurred. That is, the information or events are transmitted in real time. These can include (but are not limited to) notification when a battery 76 needs replacement, when a user has been banned or tracked, or when a security access control device 20 has been in an undesirable state for too long.

For example, if a user opens a door in this access controlled system, and leaves it propped open with a chair, the door will send a notification of the event. Administrators can configure custom policies to handle these events. For example, if the voltage of the battery 76 becomes too low, the event received by the controller 26 can be forward in the form of an email to maintenance crew, who can change the battery

If for any reason a security access control device 20 loses power, due to battery failure or loss of external power (if not battery powered), all event, log and user list data is retained This is made possible by switching to a backup battery 76 when the primary power source 74 fails When this happens, the security access control device 20 stores relevant data, locks the physical access point 22, and brings everything to an extremely low power state. This makes the security access control device 20 inoperable for normal user use, yet it retains all necessary data and timing information.

Security access control devices 20 in the system 10, as well as users, have the ability to be “grouped”. Security access control device 20 grouping and user grouping allows for privileges to apply to not only individual entities, but to span across defined groups. Access group IDs can be programmed on access media 66, giving users access to all physical access points 22 in the specified group.

In addition, security access control devices 20 can operate exclusively on the concept of user groups. This would allow the security access control device 20 an extra level of discrimination at the door. For example, if a security access control device 20 is in a mode that is only accepting users from certain groups, users of other groups will not be granted access even if they possess the proper timing credentials.

This gives the ability for security access control devices 20 to down-select the users or groups allowed entry for any given time with means other than exploiting the user access list. A system administrator can customize security access control device 20 schedules for a particular user group. All users that are a member of that group automatically inherit that schedule, in addition to any security access control device 20 or security access control device groups the user has access to. This feature is especially useful when managing large sets of users.

The security access control system uses access media 66 to store complex user schedules in a highly secure manner. This user schedule contains a directory of security access control devices 20 and security access control device groups the user has access to. Custom start and expiration dates may be specified for each directory entry. As noted above, this information is stored in table form in the host control station 30, and is transmitted to any particular security access control device 20 as control data.

In addition, a weekly recurrence schedule can be configured for each entry. For example, an operator could configure a user's card 66 data to allow access to a particular group of rooms (physical access points) in a building from the beginning of January through the end of December of a given year. During this period, the operator can refine the scope of access to only allow entry on Mondays, from 1:30 pm to 3:30 pm, for example. Customized scheduling was designed around a university environment allowing great flexibility for a large number of users, each with different access needs.

In addition to fine-grained access data, personal information specific to the user is also stored on the access media 66. This information can be used at access kiosks, allowing users to download their pre-configured access schedule directly to their card, by simply entering a personal identification number (PIN). This could reduce the demand on operators to program user cards. Due to the sensitive nature of this information, the system employs access media supporting complex authentication and encryption protocols.

The software architecture is based on a three-tier design as shown in FIG. 3. The main software components are the server application 80, the data storage application 82, and the client application 84. A centralized server coordinates all system activity requested by connected clients. Each of these components can be deployed on independent machines or on a single machine.

Communication among the components is conducted via an Ethernet network. Communication to the locks is achieved via system controllers, which can be distributed among several client components. The server is the central component of the system. All the clients communicate and share information through the server.

In addition, the server monitors the commands issued by the clients to avoid operations that would lead to conflicts in the system 10. The data storage component 80 stores user access data and lock data. It provides the capability to persist user information and information stored on a smart card 66. Also, it allows persistent relevant information about a lock such as schedule events, battery status, user access logs, user block logs, and user track logs. The client component is the primary interface to the system. It allows the operator to manage user access information and the ability to store this information on a smart card 66. In addition, it provides the ability to manage locks, execute wireless commands and receive events from a lock.

The communication backbone of the system 10 is the ad hoc wireless network. Each node (security access control device 20 or repeater 23) acts as an intermediate router and cooperates in carrying traffic between communicating nodes. A message sent from a particular source may be relayed by several intermediate nodes before arriving at its destination. Due to this multi-hop capability, all nodes are not required to be within range of a centralized gateway or hub, as in infrastructure-based wireless networks.

The only requirement to support this means of communications is that each node must be in range of another node, providing a means for a multi-hop path from one point to another. As shown in FIG. 1, active paths between communicating nodes are depicted. One active path is between the security access control device 20(1) and the host control station 30, and another active path is between the repeater 23 and the security access control device 20(4), for example. The figure depicts the extent of each node's wireless range with a circle 40, 50(1)-50(n) and 60, with the controller or access point at the center. The jagged lines in the figure illustrate the communications and the intermediate security access control devices 20 that are used to relay the message.

In the scope of the disclosed security access control system 10, the ad hoc protocol used is optimized for battery operation and low mobility, since most security access control devices 20 in the system will be battery powered and stationary. The protocol implemented uses dynamic route discovery with route caching.

Essentially, paths to and from various security access control devices 20 are generated when they are needed, and then stored for future use. Cached routes are likely to save the time and power overhead of path generation on subsequent communications since the physical network topology does not change much. When a path is required in the system 10, and there is no routing information stored in the route cache for the destination, special broadcast messages are propagated throughout each node in the network.

Any node that has knowledge or is within range of the destination sends the required routing information along the path that it received the special broadcast message from. These routing messages are cached at each node so that subsequent transmissions are faster and require less overhead. There are a number of protocols that can be tailored to achieve this capability, such as Ad hoc On Demand Distance Vector (AODV) or Dynamic Source Routing (DSR) protocols, for example. Other protocols are acceptable as readily appreciated by those skilled in the art.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A security access control system comprising:
a plurality of security access control devices at respective physical access points for controlling physical access thereat;
each security access control device comprising a wireless transceiver and a controller cooperating therewith to establish a wireless ad hoc network among said plurality of security access control devices.

2. A security access control system according to claim 1 further comprising at least one additional security access control device that is out of range of said plurality of access control devices; and at least one repeater for extending the wireless ad hoc network to said at least one additional security access control device.

3. A security access control system according to claim 1 further comprising a host control station comprising a wireless transceiver and a host controller cooperating therewith to communicate to at least one of said plurality of security access control devices via the wireless ad hoc network.

4. A security access control system according to claim 3 wherein said host control station transmits control data to at least one of said plurality of security access control devices via the wireless ad hoc network.

5. A security access control system according to claim 4 wherein the control data comprises at least one of an unlocked state, a card controlled state, an access disabled state, and a dual mode state for any one of said security access control devices.

6. A security access control system according to claim 4 wherein the control data is used for controlling user access to any one of said plurality of physical access points.

7. A security access control system according to claim 6 further comprising a timer so that the control data for controlling user access to any one of said plurality of physical access points is based upon a time of day.

8. A security access control system according to claim 6 wherein the control data comprises data for tracking, banning, blocking and accepting user access.

9. A security access control system according to claim 3 wherein at least one of said plurality of security access control devices transmits status data to said host control system via the wireless ad hoc network.

10. A security access control system according to claim 9 wherein the status data comprises at least one of battery status, user status, and security access control device operating status.

11. A security access control system according to claim 10 wherein the status data is transmitted in real time.

12. A security access control system according to claim 10 wherein the security access control device operating status comprises at least one of an unlocked state, a card controlled state, an access disabled state, and a dual mode state.

13. A security access control system according to claim 3 wherein the status data comprises audit data, the audit data including system events, access attempts by a user, and a time and access event outcome of the access attempts made by the user.

14. A security access control system according to claim 1 wherein said controller of said security access control device comprises a memory, and at least one of a processor and programmable gate array coupled thereto.

15. A security access control system according to claim 14 wherein said memory stores user access control data in at least one of a user block list, a user ban list, a user accept list and a user track list.

16. A security access control system according to claim 1 wherein each of said plurality of access control devices comprises an access media reader cooperating with said controller for reading an access media device when presented thereto by a user.

17. A security access control system according to claim 1 wherein each of said plurality of access control devices comprises a lock control driver coupled to said controller.

18. A security access control system according to claim 17 wherein each of said plurality of access control devices comprises at least one of an access media reader, a keypad and a fingerprint sensor for operating said lock control driver.

19. A security access control system according to claim 1 wherein each of said plurality of access control devices further comprises a timer coupled to said controller.

20. A security access control system according to claim 1 wherein the wireless ad hoc network operates based upon at least one of ad hoc on demand distance vector (AODV) and dynamic source routing (DSR) protocols.

21. A security access control system according to claim 1 wherein all of the physical access points are fixed physical access points.

22. A security access control system comprising:
a plurality of security access control devices at respective physical access points for controlling physical access thereat;
each security access control device comprising a wireless transceiver and a controller cooperating therewith to establish a wireless ad hoc network among said plurality of security access control devices; and
a host control station comprising a wireless transceiver and a host controller cooperating therewith to exchange control and status data with said plurality of security access control devices via the wireless ad hoc network.

23. A security access control system according to claim 22 further comprising at least one additional security access control device that is out of range of said plurality of access control devices; and at least one repeater for extending the wireless ad hoc network to said at least one additional security access control device.

24. A security access control system according to claim 22 wherein the control data is used for controlling user access to any one of said plurality of physical access points.

25. A security access control system according to claim 22 wherein the status data comprises at least one of battery status, user status, and security access control device operating status.

26. A security access control system according to claim 22 wherein the status data comprises audit data, the audit data including system events, access attempts by a user, and a time and access event outcome of the access attempts made by the user.

27. A security access control system according to claim 22 wherein each of said plurality of access control devices comprises a lock control driver coupled to said controller; and wherein each of said plurality of access control devices comprises at least one of an access media reader, a keypad and a fingerprint sensor for operating said lock control driver.

28. A security access control method comprising:
positioning a plurality of security access control devices at respective physical access points, each security access control device comprising a wireless transceiver and a controller cooperating therewith;
establishing a wireless ad hoc network among the security access control devices using the wireless transceivers and controllers thereof; and
controlling physical access at the physical access points using the security access control devices.

29. A security access control method according to claim 28 further comprising positioning at least one additional security access control device that is out of range of the plurality of access control devices; extending the wireless ad hoc network to the at least one additional security access control device using at least one repeater.

30. A security access control method according to claim 28 further comprising positioning a host control station comprising a wireless transceiver and a host controller cooperating therewith to communicate to at least one of the plurality of security access control devices via the wireless ad hoc network.

31. A security access control method according to claim 30 wherein the host control station transmits control data to at least one of the plurality of security access control devices via the wireless ad hoc network.

32. A security access control method according to claim 31 wherein the control data comprises at least one of an unlocked state, a card controlled state, an access disabled state, and a dual mode state for any one of the security access control devices.

33. A security access control method according to claim 31 wherein the control data is used for controlling user access to any one of the plurality of physical access points.

34. A security access control method according to claim 33 wherein the control data comprises data for tracking, banning, blocking and accepting user access.

35. A security access control method according to claim 30 wherein at least one of the plurality of security access control devices transmits status data to the host control system via the wireless ad hoc network.

36. A security access control method according to claim 35 wherein the status data comprises at least one of battery status, user status, and security access control device operating status.

37. A security access control method according to claim 36 wherein the status data is transmitted in real time.

38. A security access control method according to claim 36 wherein the security access control device operating status comprises at least one of an unlocked state, a card controlled state, an access disabled state, and a dual mode state.

39. A security access control method according to claim 30 wherein the status data comprises audit data, the audit data including system events, access attempts by a user, and a time and access event outcome of the access attempts made by the user.

40. A security access control method according to claim 28 wherein each of the plurality of access control devices comprises a lock control driver coupled to the controller; and wherein each of the plurality of access control devices comprises at least one of an access media reader, a keypad and a fingerprint sensor for operating the lock control driver.
